(19) United States
(12) Patent Application Publication
(10) Pub. No.: US 2010/0172609 A1
(43) Pub. Date: Jul. 8, 2010

(54) METHOD AND DEVICE TO IMPROVE SIGNAL-TO-NOISE RATIO IN HIGH-SPEED OPTICAL DATA COMMUNICATIONS

(75) Inventors: David R. Rolston, Beaconsfield (CA); Rajiv Iyer, Brossard (CA); Shao-Wei Fu, Delson (CA); Richard Mainardi, Montreal (CA); Eric Schneider, Longueuil (CA); Shuang Jin, St-Laurent (CA)

Correspondence Address: BENOIT & COTE, s.e.n.c., 1001, DE MAISONNEUVE BOULEVARD WEST, SUITE 210, MONTREAL, QC, H3A 3C8, CA

(73) Assignee: Reflex Photonics Inc., Montreal (CA)

(21) Appl. No.: 12/501,110

(22) Filed: Jul. 10, 2009

Related U.S. Application Data
(60) Provisional application No. 61/080,027, filed on Jul. 11, 2008.

(51) Int. Cl. G02B 6/10

(52) U.S. Cl. 385/14

(57) ABSTRACT

There is described an opto-electronic Integrated Circuit Board (ICB) comprising an ICB substrate; a linear array of cells positioned on the ICB substrate, for optical connection to an array of optical fibers, each one of the cells comprising: a die bond pad and one of a Vertical Cavity Surface Emitting Laser (VCSEL) and a Photodetector; a number of ICB bond pads on the ICB substrate, the number of ICB bond pads corresponding at least to a number of cells in the linear array, wherein each successive ICB bond pad along the linear array is located on alternate sides of the linear array; and wirebonds each connecting, in a one-to-one relationship, each one of the ICB bond pads to a corresponding die bond pad of one of the cells of the linear array.

### CROSS-REFERENCE TO RELATED APPLICATIONS

This application claims priority under 35USC§119e of U.S. provisional patent application 61/080,027 filed Jul. 11, 2008, the specification of which is hereby incorporated by reference.

### TECHNICAL FIELD

The present description relates to the field of optical data communications and more specifically to the opto-electronic devices used in optical data communications.

### BACKGROUND

Short-haul data communication (<300 m) rates have progressively increased from <1 Gbps to >10 Gbps over the past decade. Most of the existing technologies to convert the data from the electrical domain to the optical domain are single-channel (i.e. only one transmitter and one receiver). Parallel-channel technologies have emerged to provide a significant increase in the overall aggregate communication bandwidth of the communication system.

Because most parallel solutions use fiber-ribbons in which the individual fibers are separated by a pitch of 250 microns, it is necessary that the optoelectronic components (the lasers and photodetectors) are also equally pitched at 250 microns on their respective arrays. For 10 Gbps data rates and greater, the wirebonds that connect the optoelectronic chips to their substrate behave as antennas, which contribute to crosstalk—where the signal from one channel is electrically picked-up by its neighbouring channels, degrading the signal integrity resulting in bit-errors. Naturally, crosstalk is reduced by increasing the separation between neighbouring wirebonds.

A prior art wirebonding method consists of vertical cavity surface emitting lasers (VCSELs) and photodetectors (PDs) for parallel optical data communications which are typically configured in an array pitched at 250 microns. FIG. 1 shows an example of a “1×4 VCSEL array” from U.L.M. Photonics. Wirebonding the optoelectronic components on the array to the substrate/board beneath are typically single-sided as shown in FIG. 1, and therefore fixed to the same pitch as the arrayed components.

### SUMMARY

### Definitions

In the present document, the following acronyms apply:
VCSEL(s) means Vertical Cavity Surface Emitting Laser(s);
PD(s) means Photodetector(s);
ICB means Integrated Circuit Board;
PCB means Printed Circuit Board;
TIA means TransImpedance Amplifier.

Furthermore, those skilled in the art will recognize that “a linear array of cells” may be equivalent to “a die” or “a chip” which includes the same or similar components. These words may thus be used interchangeably in the present description.

Since the pitch between the VCSELs and PDs is fixed at 250 microns (restricted by the pitch of the array of optical fiber), there is proposed an alternate wirebonding scheme to increase the separation between neighbouring wirebonds to reduce crosstalk and improve signal integrity.

In accordance with an embodiment, there is provided an opto-electronic Integrated Circuit Board (ICB) comprising an ICB substrate; a linear array of cells positioned on the ICB substrate, for optical connection to an array of optical fibers, each one of the cells comprising: a die bond pad and one of a Vertical Cavity Surface Emitting Laser (VCSEL) and a Photodetector; a number of ICB bond pads on the ICB substrate, the number of ICB bond pads corresponding at least to a number of cells in the linear array, wherein each successive ICB bond pad along the linear array is located on alternate sides of the linear array; and wirebonds each connecting, in a one-to-one relationship, each one of the ICB bond pads to a corresponding die bond pad of one of the cells of the linear array.

In accordance with another embodiment, there is provided an opto-electronic Integrated Circuit Board (ICB) adapted to receive a linear array of cells, each one of the cells being for optical connection to an optical fiber, and each one of the cells comprising a die bond pad and one of: a Vertical Cavity Surface Emitting Laser (VCSEL) and a Photodetector. The ICB comprises: an ICB substrate for positioning the linear array thereon; a number of ICB bond pads on the ICB substrate, the number of ICB bond pads corresponding at least to a number of cells, where each ICB bond pad is for connection, in a one-to-one relationship, to a corresponding die bond pad; and a number of trace lines on the ICB substrate, the number of trace lines corresponding to the number of ICB bond pads, the trace lines each having a proximate end and a distal end, the proximate end being connected to a corresponding one of the ICB bond pads, wherein a first distance between distal ends of neighbouring trace lines is greater than a second distance between proximate ends of the same neighbouring trace lines.

In accordance with yet another embodiment, there is provided an opto-electronic Integrated Circuit Board (ICB) adapted to receive an array of cells for optical connection to an array of optical fibers, each cell comprising a die bond pad and one of a Vertical Cavity Surface Emitting Laser (VCSEL) and a Photodetector. The ICB comprises: an ICB substrate for positioning the array of cells thereon; and ICB bond pads on the ICB substrate, each one of the ICB bond pads for connecting, in a one-to-one relationship, to a corresponding die bond pad of one of the cells, wherein each successive ICB bond pad is located on alternate, opposite sides of the array of cells.

In accordance with still another embodiment, there is provided a method for making an opto-electronic Integrated Circuit Board (ICB). The method comprises: providing an array of cells for optical connection to an array of optical fibers, each cell comprising a die bond pad and one of: a Vertical Cavity Surface Emitting Laser (VCSEL) and a Photodetector; providing an ICB substrate defining a space thereon for receiving the array; laying out a number of ICB bond pads on the ICB substrate, the number of ICB bond pads corresponding at least to the number of cells, each successive ICB bond pad being located on the ICB substrate, on alternate sides of the space; installing the array of cells in the space; and connecting, in a one-to-one relationship, each ICB bond pad to a corresponding die bond pad, using individual wirebonds for each connection.

### BRIEF DESCRIPTION OF THE DRAWINGS

FIG. 1a is a first schematic view of a wire bonding layout on an opto-electronic Integrated Circuit Board (ICB) and a Printed Circuit Board (PCB), in accordance with the prior art;

FIG. 1b is a second schematic view of a wire bonding layout on an opto-electronic Integrated Circuit Board (ICB) and a Printed Circuit Board (PCB), in accordance with the prior art;

FIG. 1c is a third schematic view of a wire bonding layout on an opto-electronic Integrated Circuit Board (ICB) and a Printed Circuit Board (PCB), in accordance with the prior art;

FIG. 1d is a fourth schematic view of a wire bonding layout on an opto-electronic Integrated Circuit Board (ICB) and a Printed Circuit Board (PCB), in accordance with the prior art;

FIG. 1e is a fifth schematic view of a wire bonding layout on an opto-electronic Integrated Circuit Board (ICB) and a Printed Circuit Board (PCB), in accordance with the prior art;

FIG. 2 is a schematic view of an opto-electronic Integrated Circuit Board in accordance with an embodiment;

FIG. 3 is a block diagram illustrating a method of making the opto-electronic Integrated Circuit Board of FIG. 2 in accordance with an embodiment;

FIG. 4 is a block diagram illustrating a method of laying out a number of ICB bond pads on the ICB substrate of FIG. 2 in accordance with an embodiment;

FIG. 5 is a schematic view of an opto-electronic ICB on a PCB, with a wire bonding layout in accordance with an embodiment;

FIG. 6 is another schematic view of an opto-electronic ICB on a PCB, with a wire bonding layout in accordance with an embodiment;

FIG. 7 is yet another schematic view of an opto-electronic ICB on a PCB with a wire bonding layout in accordance with an embodiment;

FIG. 8 is yet again another schematic view of an opto-electronic ICB on a PCB with a wire bonding layout in accordance with an embodiment; and

FIG. 9 is still another schematic view of an opto-electronic ICB on a PCB with a wire bonding layout in accordance with an embodiment.

### DETAILED DESCRIPTION

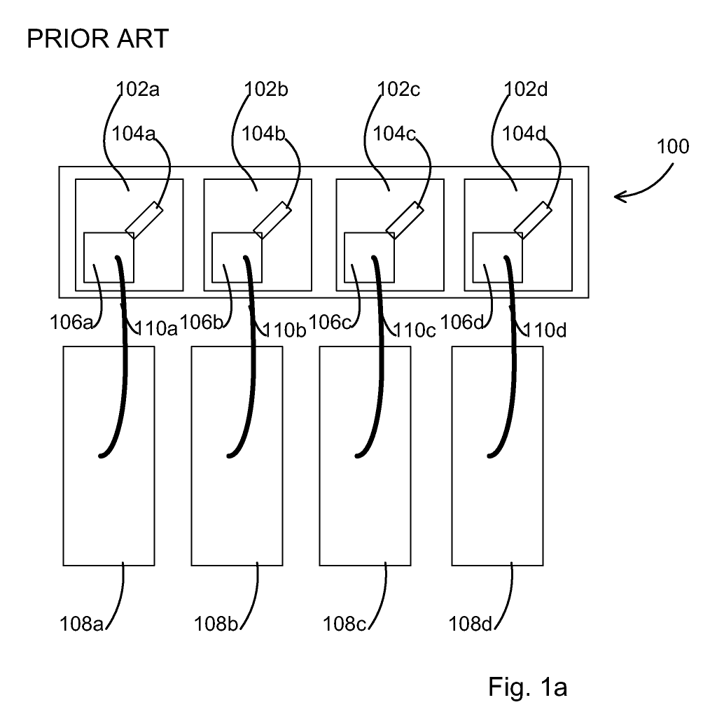

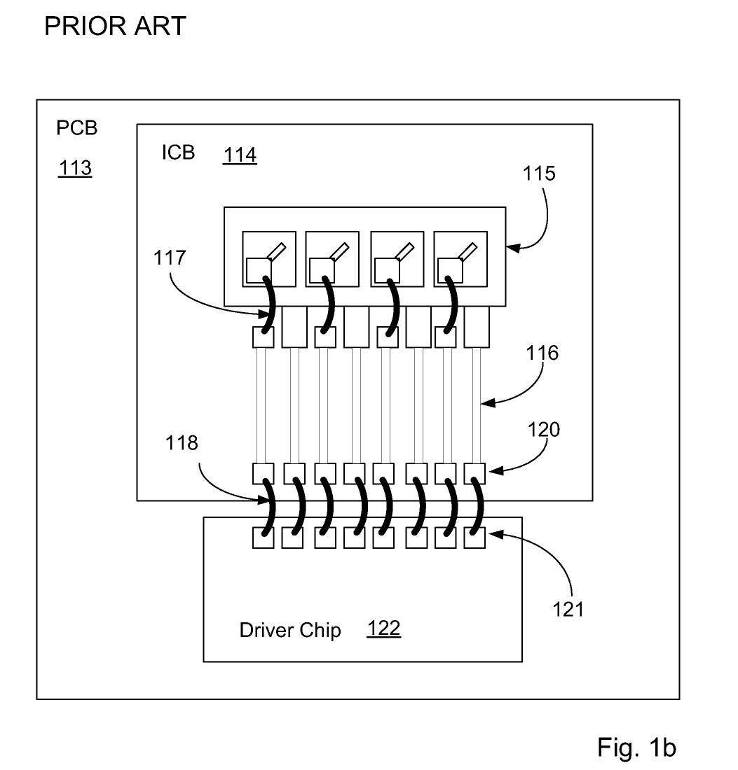

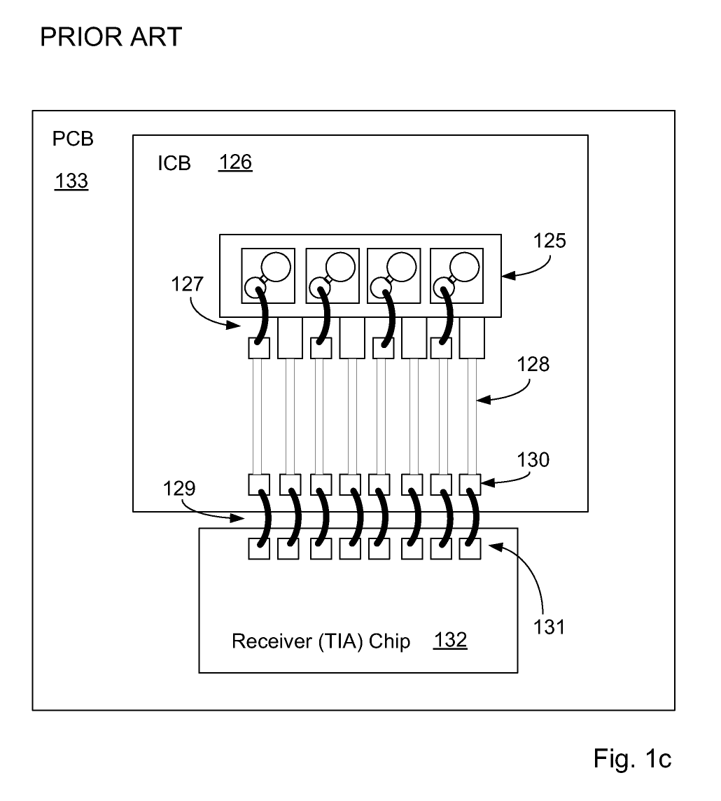

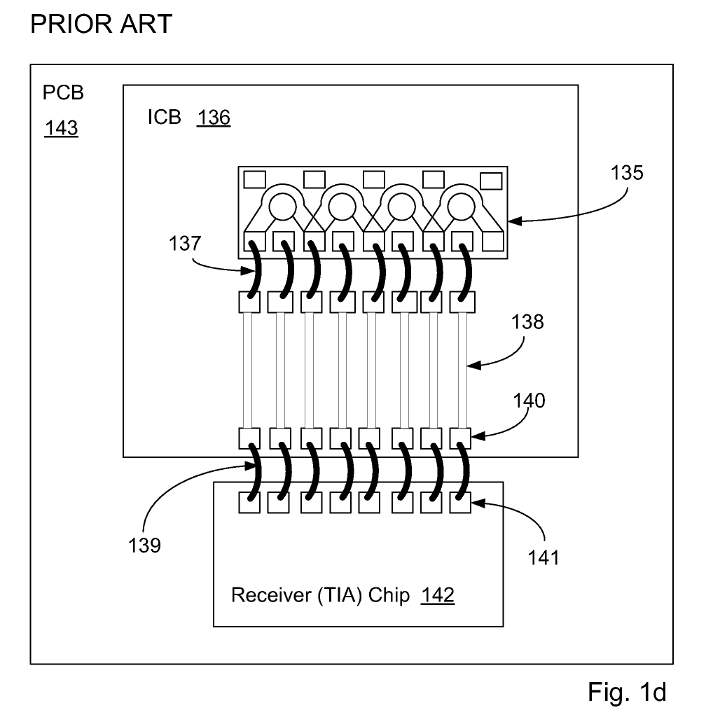

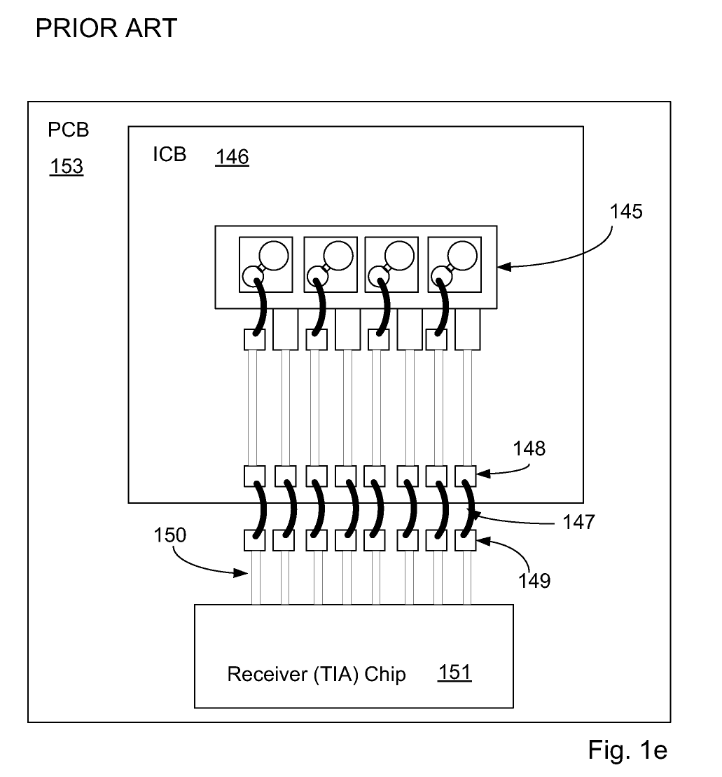

FIG. 1a illustrates a prior art wire bonding layout starting from a regular 1×4 VCSEL array of cells 100 currently offered by providers. In this embodiment the array is pitched at 250 micrometers. Each cell comprises one VCSEL 104a, 104b, 104c or 104d connected to one corresponding die bond pad 106a, 106b, 106c or 106d fixed together on a respective substrate 102a, 102b, 102c or 102d or on a single substrate (not shown). This FIG. 1 illustrates wirebonds 110a, 110b, 110c and 110d connecting each die bond pad 106a, 106b, 106c or 106d to one corresponding ICB bond pad 108a, 108b, 108c or 108d, all set on the same side of the array of cells 100.

FIG. 1b illustrates another prior art layout starting with a readily available 1×4 Common Cathode VCSEL Array Die 115 on ICB 114, illustrating ICB wirebonds 117 and trace lines 116 to the edge of the ICB, and wirebonds 118 from ICB edge bond pads 120 to the bond pads 121 on the Driver chip 122. The Driver Chip 122 is electrically and mechanically attached to the PCB 113.

FIG. 1c illustrates another prior art layout starting with a readily available 1×4 Common Cathode PD Array Die 125 on ICB 126, illustrating ICB wirebonds 127 and trace lines 128 to the edge of the ICB, and wirebonds 129 from ICB edge bond pads 130 to the bond pads 131 on the Receiver (TIA) chip 132. The Receiver (TIA) Chip 132 is electrically and mechanically attached to the PCB 133.

FIG. 1d illustrates another prior art layout starting with a readily available non-common-cathode 1×4 PD Array Die 135 on ICB 136, illustrating wirebonds 137 and trace lines 138 to the edge of the ICB, and wirebonds 139 from ICB edge bond pads 140 to the bond pads 141 on the Receiver (TIA) chip 142. The Receiver (TIA) Chip 142 is electrically and mechanically attached to the PCB 143.

FIG. 1e illustrates another prior art layout starting with a readily available 1×4 Common Cathode PD Array Die 145 on ICB 146, illustrating wirebonds 147 from ICB edge bond pads 148 to PCB bond pads 149, and trace lines 150 from the PCB bond pads 149 to the electrical connections (not shown) on the Receiver (TIA) chip/die 151. The Receiver (TIA) Chip 151 is electrically and mechanically attached to the PCB 153.

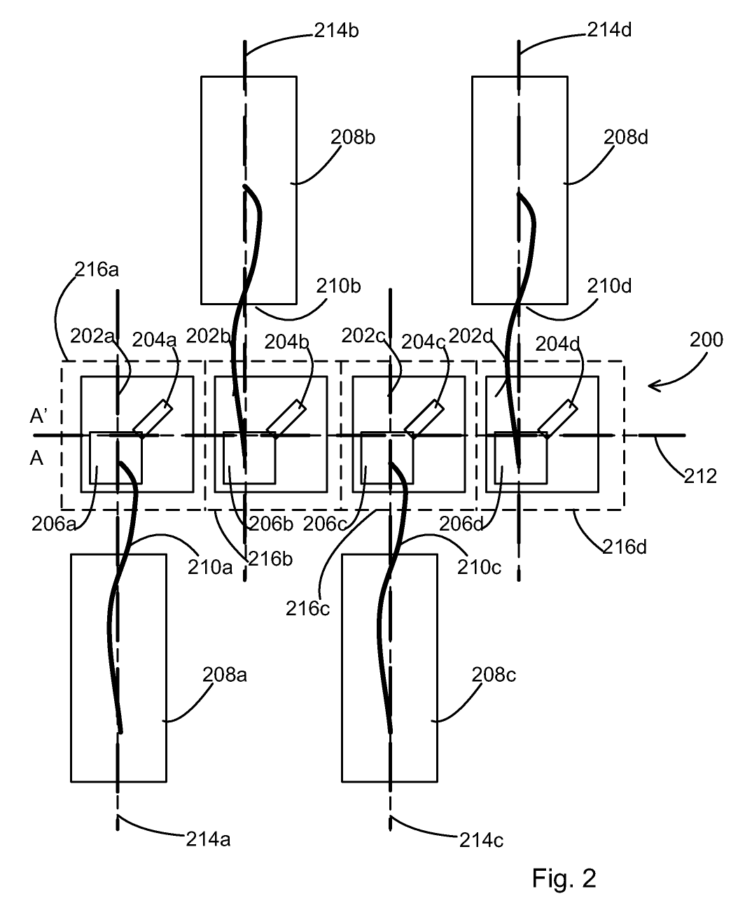

FIG. 2 illustrates a new wire bonding layout starting from a readily available 1×4 VCSEL array 200 of cells 216a, 216b, 216c and 216d, or from any other type of array die of light detecting or light emitting cells. In this illustrated embodiment the array 200 of cells 216a, 216b, 216c and 216d is pitched at 250 micrometers. Therefore the space between each VCSEL or each PD is 250 micrometers. Each cell 216a, 216b, 216c and 216d comprises one VCSEL 204a, 204b, 204c or 204d connected to one corresponding die bond pad 206a, 206b, 206c or 206d fixed together on a respective substrate 202a, 202b, 202c, 202d, or on a single common substrate. This FIG. 2 illustrates wirebonds 210a, 210b, 210c and 210d connecting each die bond pad 206a, 206b, 206c or 206d to one corresponding ICB bond pad 208a, 208b, 208c or 208d oriented in an alternate layout with respect to the array line 212. The wirebond axis 214a, 214b, 214c and 214d are defined for each wirebond 210a, 210b, 210c or 210d as the average wirebond 210a, 210b, 210c or 210d axis which passes about or at the center point of the corresponding die bond pad 206a, 206b, 206c or 206d. In this embodiment, the axis of the longer dimension of each ICB bond pads 208a, 208b, 208c and 208d is equivalent to the corresponding wirebond axis 214a, 214b, 214c or 214d.

Following the array line 212 from the left to the right, the first die bond pad 206a is connected to the ICB bond pad 208a, located on a first side A of the array line 212. In this embodiment, the value of the angle created by the array line 212 and the wirebond axis 214a is around 90°. Following on the array line 212, the second die bond pad 206b is connected to another ICB bond pad 208b, located on the second opposite side A′ of the array line 212. Following on the array line 212, the third die bond pad 206c is connected to another ICB bond pad 208c, located on the first side A of the array line 212. The following die bond pads 206d and next (not shown), are each separately connected to a respective other ICB bond pad, here bond pad 208d and a next bond pad (not shown), each bond pad being located about axis 212, alternating from opposite side A′ to side A. In this embodiment, wirebond axes 214a, 214b, 214c and 214d are parallel to each other, but may be disposed otherwise.

In FIG. 2, a readily available 1×4 PD (Photodetector) array of cells can take place of the 1×4 VCSL array of cells 200 shown. Each cell is intended for connection to an optical fiber, wherein the array of cells is for optical connection to an array of optical fibers such as an optical fiber ribbon, an array of light coupling and transmitting waveguides, and the like.

Those skilled in the art will understand that the array of light-emitting or light-detecting cells set out in the present description are not limited to 1×4 arrays, and are applicable to arrays of cells in general regardless of their dimensions.

In addition, although FIG. 2 depicts ICB bond pads 208a, 208b, 208c, 208d as having a rectangular-like shape, with a long side of the rectangular-like shape being at substantially 90 degrees with respect to the array line 212 or any line which crosses a row of cells in the array, other configurations are possible. The ICB bond pads for example, may be of any other shape, with one of their sides forming any given angle with the array line 212.

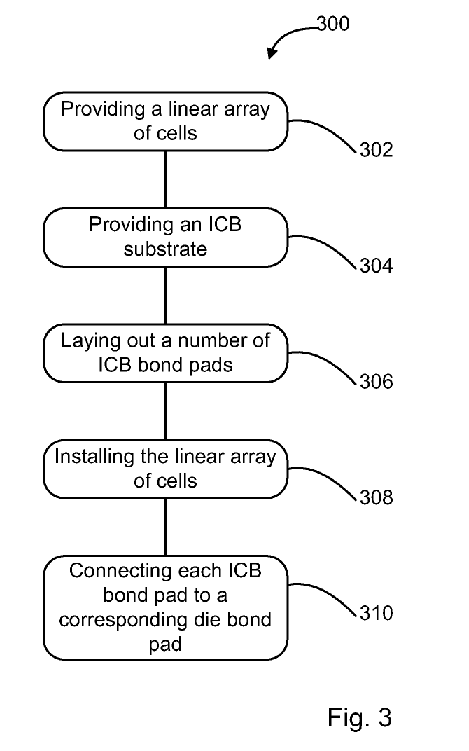

Turning now to FIG. 3 which illustrates a method 300 for making an opto-electronic ICB for the purpose of reducing crosstalk in high-speed optical data communications. The method 300 comprises the following steps:

Step 302: providing a linear array of cells, each cell comprising a Vertical Cavity Surface Emitting Laser (VCSEL) or a Photodetector for optical connection to an array of optical fibers, and a die bond pad;
Step 304: providing an ICB substrate comprising a linear space which defines an array line which crosses each cell;
Step 306: laying out a number of ICB bond pads on the ICB substrate, the number of ICB bond pads corresponding to a number of cells to be used, each successive ICB bond pad being located on the substrate on alternate sides of the linear space;
Step 308: installing the linear array of cells in the linear space; and
Step 310: connecting, in a one-to-one relationship, each ICB bond pad to a corresponding die bond pad, using individual wirebonds for each connection.

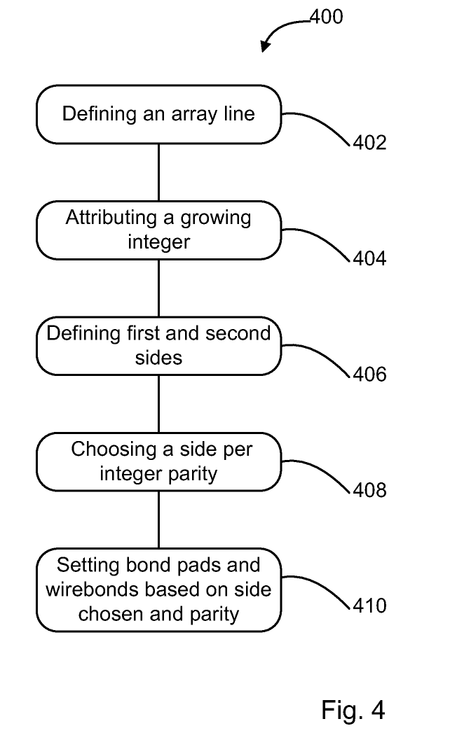

Turning now to FIG. 4 which illustrates a method 400 for laying out a number of ICB bond pads on the ICB substrate for the purpose of reducing crosstalk in high-speed optical data communications. The method 400 comprises the following steps:

Step 402: Defining an array line (such as axis 212 in FIG. 2 described above) which crosses each substrate (such as elements 202a, 202b, 202c and 202d of the array of dies 200 in FIG. 2 described above).
Step 404: From one end of the array line 212 to the other, successively attributing a growing integer by steps of “1” at each die bond pad 206a, 206b, 206c and 206d of each cell 216a, 216b, 216c and 216d crossed (refer to FIG. 2 described above).
Step 406: Defining a first side and a second side about the array line defined in step 402 (such as axis 212 in FIG. 2 described above), the first and second sides being either opposite from each other.
Step 408: Choosing one of the first and second sides for laying out odd numbered die bond pads therefrom. Such choosing thus leaves the remaining one of the first and second sides for laying out even numbered die bond pads therefrom.
Step 410: Laying out the ICB bond pads (such as 208a, 208b, 208c and 208d in FIG. 2 above) and corresponding wirebonds (such as 210a, 210b, 210c and 210d in FIG. 2 above) in accordance with the respective first or second side as chosen in step 408, and depending on the parity of the number attributed to each die bond pad 206a, 206b, 206c or 206d.

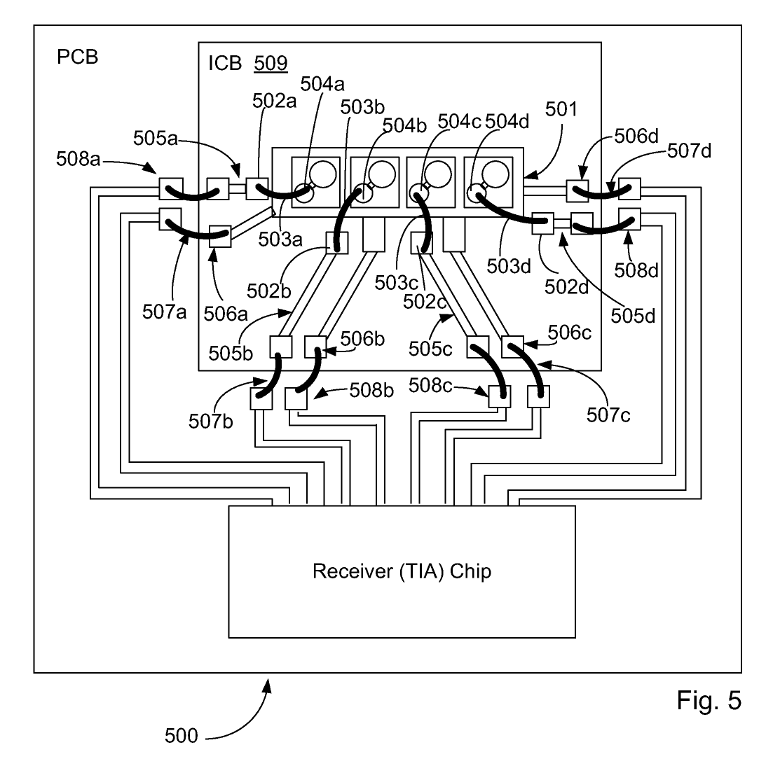

Turning to FIG. 5 there is illustrated a layout 500 in accordance with another embodiment of this invention starting with a readily available 1×4 Common Cathode PD Array Die 501 on ICB 509. Every ICB bond pads 502a, 502b, 502c, 502d are located on the same lower side of the Array Die 501. Wirebonds 503a, 503b, 503c, 503d link each die bond pad 504a, 504b, 504c, 504d on the Array Die 501 to the corresponding ICB bond pads 502a, 502b, 502c, 502d on the ICB 509. From the ICB bond pads 502a, 502b, 502c, 502d, pairs of trace lines 505a, 505b, 505c, 505d on the ICB 509 fani out from each other to the corresponding pair of ICB edge bond pads 506a, 506b, 506c and 506d. As the trace lines 505a, 505b, 505c, 505d are spaced apart, this layout reduces noise pickup caused by a grouping of ICB trace lines together. In the same manner, signal crosstalk is also reduced by the spacing between the trace lines. Reduction of noise and crosstalk tends to improve signal-to-noise ratio of high data rate optical communications devices.

Still in reference to FIG. 5, it is shown that the number of trace lines 505a, 505b, 505c, 505d corresponds to the number of ICB bond pads 502a, 502b, 502c, 502d. In addition, each trace line has a proximate end and a distal end, the proximate end being connected to a corresponding one of the ICB bond pads 502a, 502b, 502c, 502d while the distal end is connected to a corresponding one of the ICB edge bond pads 506a, 506b, 506c and 506d. The distance between distal ends of neighbouring trace lines (such as trace lines 505b and 505c) is also kept greater than a distance between proximate ends of the same neighbouring trace lines.

In the herein described layouts, such as shown by FIG. 5 and below-detailed figures, the wirebonds from the array die to the ICB substrate and the wirebonds from the ICB edge bond pads to the PCB bond pads or Chip bond pads are chosen to have a height profile which reduces “loop inductance”. This is done for example by having the height profile (or a loop height) as low as possible. Typically, wirebonds may have a loop height of approximately 4 to 6 thousandths of an inch. This typical loop height however introduces loop inductance which degrades high-speed signals passing therethrough. For this reason, the loop height is kept to less than 1 thousandths of an inch to minimize the loop inductance in accordance with an embodiment. Other loop height profiles or readily available techniques can be used to minimize loop inductance. In addition, loop height of the wirebonds can be determined based on their proximity to the optical fibers, for example, the later being positioned for connection to the array of cells.

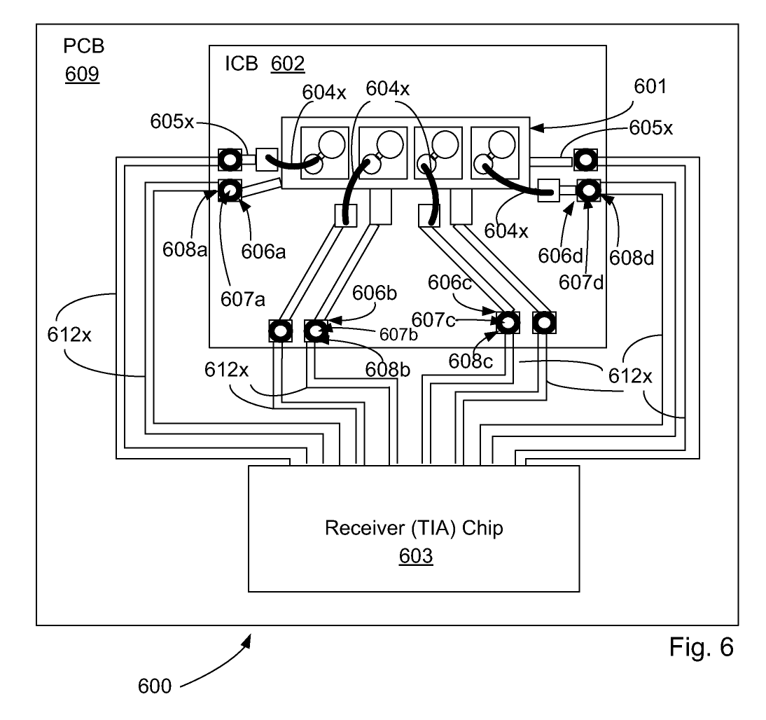

Turning to FIG. 6, there is illustrated an alternative layout 600. Contrary to layout 500 of FIG. 5 described above, where pairs of PCB bond pads 508a, 508b, 508c, 508d are connected with respective pairs of ICB edge bond pads 506a, 506b, 506c, 506d via pairs of wirebonds 507a, 507b, 507c, 507d, layout 600 has ICB trace lines 605x at the edge of the ICB 602 which are connected to the trace lines 612x on the PCB 609 using VIAs. Pairs of the ICB VIAs 607a, 607b, 607c, 607d connect pairs of ICB trace lines 605x at the ICB VIA annuli 606a, 606b, 606c, 606d to pairs of PCB bond pads 608a, 608b, 608c, 608d. VIAs are electrical connections through drilled holes in the ICB 602. VIAs 607a, 607b, 607c, 607d may be electrically shielded using additional shielding VIAs to reduce crosstalk and noise. Crosstalk between signals is therefore further reduced.

In order to avoid signal reflections which degrade high-speed signal integrity, transmission lines connecting the 1×4 Common Cathode PD Array Die 601 on ICB 602 to the Receiver TIA Chip 603 are designed as ‘matched transmission lines’ with controlled impedance of 50-Ohm single-ended or 100-Ohm differential. Each transmission line comprises: the corresponding wirebond 604x and/or trace 605x connecting the array die 601 to the corresponding pad of the pair of ICB edge bond pad or ICB VIA annulus 606a, 606b, 606c or 606d, the corresponding wirebonds 507a, 507b, 507c or 507d (FIG. 5) or the corresponding VIA of the pair of VIAs 607a, 607b, 607c or 607d connecting the corresponding pad of the pair of ICB edge bond pads (or via annuli) 606a, 606b, 606c or 606d to corresponding pad of the pair of PCB bond pads 608a, 608b, 608c or 608d and the corresponding trace 612x connecting the corresponding pad of the pair of PCB bond pads 608a, 608b, 608c or 608d to the Receiver TIA Chip 603. This layout improves signal to noise ratio (SNR), thereby maximizing the signal integrity.

It is understood that the above described shielding of VIAs and the matching of the overall transmission lines (i.e. from the bond pad on the die 601 to the final Receiver Chip 603) can be accomplished in a variety of other ways meant to achieve best signal transmission conditions.

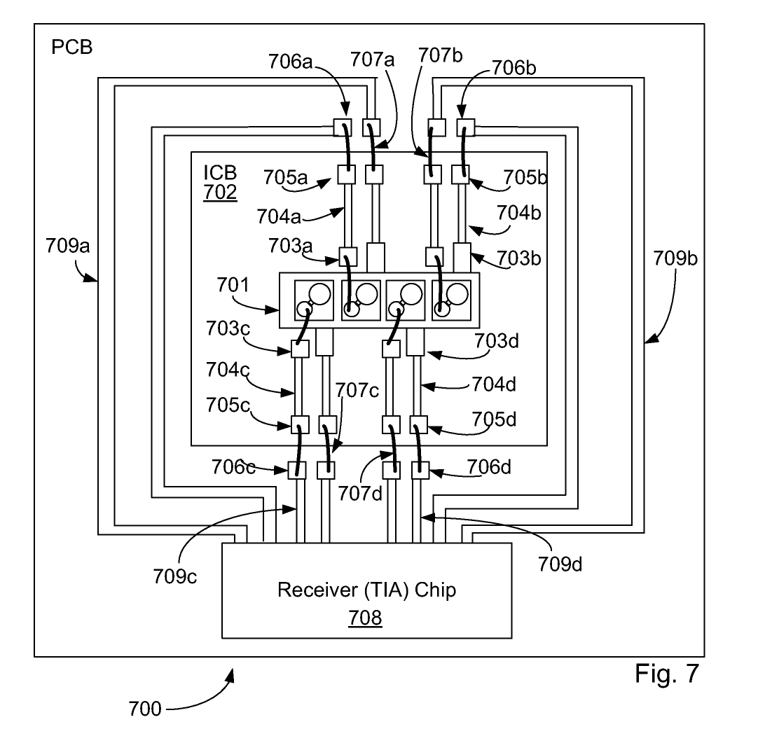

Turning now to FIG. 7, there is illustrated a layout 700 in accordance with another embodiment. A readily available 1×4 Common Cathode PD Array Die 701 is on an ICB 702. Pairs of ICB bond pad 703a, 703b, 703c, 703d and pairs of ICB traces 704a, 704a, 704b, 704c, 704d are located on alternating sides of the PD array chip 701 (or die). Pairs of ICB traces 704a, 704b, 704c, 704d connect ICB bond pads 703a, 703b, 703c, 703d to pairs of ICB edge bond pad 705a, 705b, 705c, 705d. This significantly reduces crosstalk between neighbouring channels by effectively doubling the distance between neighbouring signals. Pairs of ICB edge bond pads 705a, 705b, 705c, 705d are connected to corresponding pairs of PCB bond pads 706a, 706b, 706c, 706d with pairs of wirebond 707a, 707b, 707c, 707d. Finally, pairs of PCB bond pads 706a, 706b, 706c, 706d are connected to the Receiver TIA chip 708 with pairs of PCB trace lines 709a, 709b, 709c, 709d.

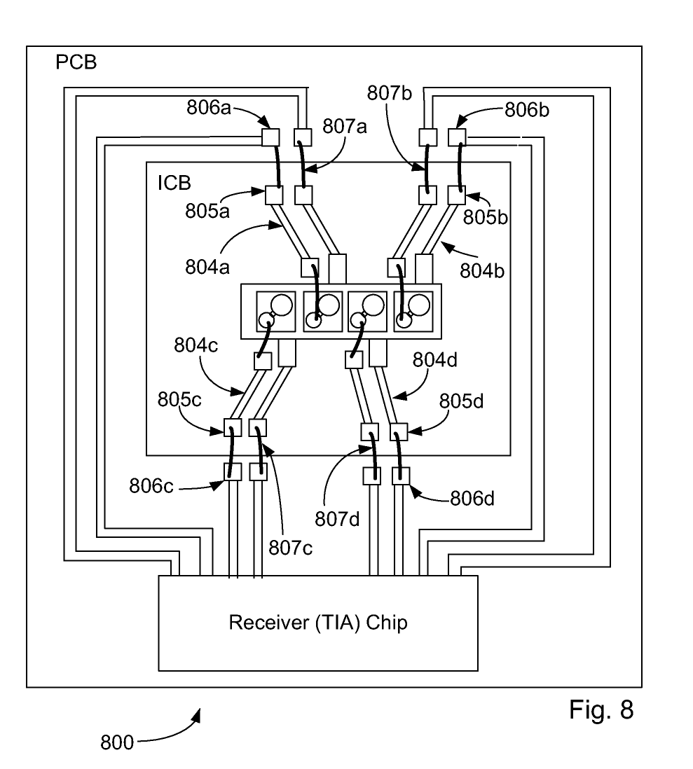

As an alternative, and turning now to FIG. 8, there is illustrated an a layout 800 having pairs of ICB traces 804a, 804b, 804c, 804d reaching ICB edges by fanning-out to pairs of ICB edge bond pads 805a, 805b, 805c, 805d. In another embodiment of this invention, VIAs could take place of the wirebonds 807a, 807b, 807c, 807d connecting the pairs of ICB edge bond pads 805a, 805b, 805c, 805d to the pairs of PCB bond pads 806a, 806b, 806c, 806d.

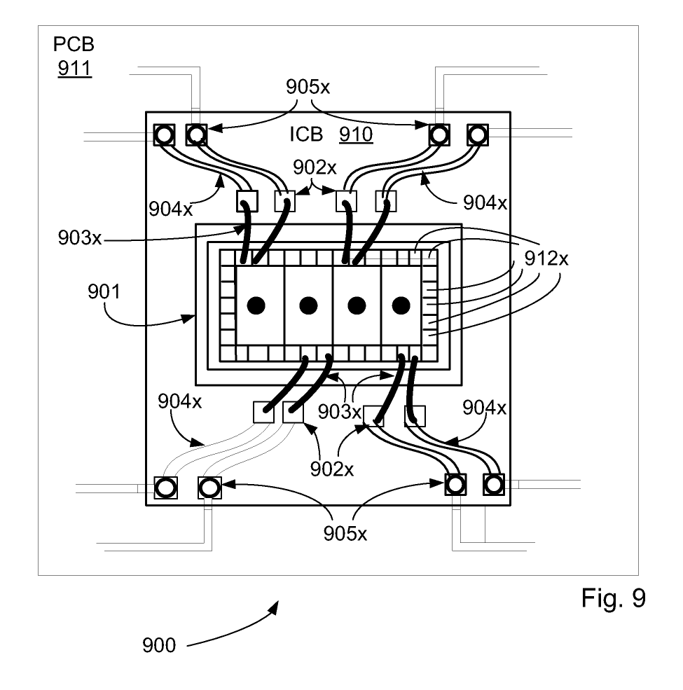

Turning now to FIG. 9, there is illustrated a layout 900 in accordance with another embodiment, having an integrated Photodetector array and TransImpendance Amplifier die 901 (PD+TIA 1×4 array). The illustrated integrated array die 901 has alternating signal locations with respect to the die. For example, the integrated die 901 can be derived or adapted from a single (i.e. 1×1 array) integrated PD+TIA, which directly amplifies the received signal before sending it down the ICB trace lines 904x to the PCB 911 (either with vias such as 905x or wirebonds such as 903x). Hence in such an embodiment, layout 900 does not have a separate Receiver (TIA) chip on the PCB 911.

Still in reference to FIG. 9, the integrated die 901 is connected to the pairs of ICB bond pad 902x with pairs of wirebond 903x. The pairs of ICB traces 904x fan-out to the corresponding pairs of ICB edge bond pad 905x. “Matched transmission lines”, low wirebond loop heights and via connections between the ICB 910 and the PCB 911 can be used in such a layout 900. The other die bond pads 912x on the integrated die 901 are usable for low-speed power, control, filtering, or for any other similar function. The wirebonds 903x, trace lines 904x, vias 905x, and other linking means may be used for these low-speed connections although they are not shown in this figure.

While preferred embodiments have been described above and illustrated in the accompanying drawings, it will be evident to those skilled in the art that modifications may be made therein without departing from the essence of this invention. Such modifications are considered as possible variants comprised in the scope of the invention.

1. An opto-electronic Integrated Circuit Board (ICB) comprising:
a. an ICB substrate;
b. a linear array of cells positioned on the ICB substrate, for optical connection to an array of optical fibers, each one of the cells comprising: a die bond pad and one of a Vertical Cavity Surface Emitting Laser (VCSEL) and a Photodetector;
c. a number of ICB bond pads on the ICB substrate, the number of ICB bond pads corresponding at least to a number of cells in the linear array, wherein each successive ICB bond pad along the linear array is located on alternate sides of the linear array; and
d. wirebonds each connecting, in a one-to-one relationship, each one of the ICB bond pads to a corresponding die bond pad of one of the cells of the linear array.

2. The opto-electronic ICB of claim 1, further comprising a number of trace lines on the ICB substrate, the number of trace lines corresponding to the number of ICB bond pads, wherein each trace line has a proximate end and a distal end, the proximate end being connected to a corresponding ICB bond pad proximate the linear array, and the distal end being connected to an ICB edge bond pad located about an edge of the ICB substrate.

3. The opto-electronic ICB of claim 2, wherein a first distance between distal ends of neighbouring trace lines is greater than a second distance between proximate ends of the same neighbouring trace lines.

4. The opto-electronic ICB of claim 1, wherein the array of optical fibers comprises an optical fiber ribbon.

5. The opto-electronic ICB of claim 1, wherein the one of the VCSEL and the Photodetector is spaced from a neighbouring one of the VCSEL and the Photodetector of a neighbouring cell by a predetermined pitch of about 250 microns.

6. An opto-electronic Integrated Circuit Board (ICB) adapted to receive a linear array of cells, each one of the cells being for optical connection to an optical fiber, and each one of the cells comprising a die bond pad and one of: a Vertical Cavity Surface Emitting Laser (VCSEL) and a Photodetector, the ICB comprising:
a. an ICB substrate for positioning the linear array thereon;
b. a number of ICB bond pads on the ICB substrate, the number of ICB bond pads corresponding at least to a number of cells, where each ICB bond pad is for connection, in a one-to-one relationship, to a corresponding die bond pad; and
c. a number of trace lines on the ICB substrate, the number of trace lines corresponding to the number of ICB bond pads, the trace lines each having a proximate end and a distal end, the proximate end being connected to a corresponding one of the ICB bond pads, wherein a first distance between distal ends of neighbouring trace lines is greater than a second distance between proximate ends of the same neighbouring trace lines.

7. The opto-electronic ICB of claim 6, wherein the distal end is for connection to a corresponding ICB edge bond pad located about an edge of the ICB substrate.

8. The opto-electronic ICB of claim 7, wherein the corresponding ICB edge bond pad is for connection to a corresponding PCB bond pad on a printed circuit board (PCB).

9. The opto-electronic ICB of claim 8, wherein the corresponding ICB edge bond pad comprises a VIA connection to the PCB.

10. The opto-electronic ICB of claim 9, wherein each transmission line, from the die bond pad to an end connection on one of the PCB and a receiver chip, is impedance matched.

11. The opto-electronic ICB of claim 6, wherein one of the ICB bond pads connect to the die bond pad via a wirebond, the wirebond having an inductance-limiting height profile.

12. The opto-electronic ICB of claim 6, wherein one of the ICB bond pads connect to the die bond pad via a wirebond, the wirebond defining a loop height, the loop height being based on a proximity of the wirebond to the optical fiber.

13. An opto-electronic Integrated Circuit Board (ICB) adapted to receive an array of cells for optical connection to an array of optical fibers, each cell comprising a die bond pad and one of a Vertical Cavity Surface Emitting Laser (VCSEL) and a Photodetector, the ICB comprising:
a. an ICB substrate for positioning the array of cells thereon; and
b. ICB bond pads on the ICB substrate, each one of the ICB bond pads for connecting, in a one-to-one relationship, to a corresponding die bond pad of one of the cells, wherein each successive ICB bond pad is located on alternate, opposite sides of the array of cells.

14. The opto-electronic ICB of claim 13, further comprising a number of trace lines on the ICB substrate, the number of trace lines corresponding to a number of the ICB bond pads, wherein each one of the trace lines is connected to a corresponding one of the ICB bond pads.

15. The opto-electronic ICB of claim 13, wherein the ICB bond pads are equally spaced with respect to one another, and along each one of the alternate, opposite sides of the array.

16. The opto-electronic ICB of claim 14, wherein the ICB bond pads each have a rectangular-like shape, a long side of the rectangular-like shape being at substantially 90 degrees with respect to a line which crosses a row of cells in the array.

17. The opto-electronic ICB of claim 13, wherein the array comprises an integrated die having a Photodetector array and TransImpendance Amplifier.
